(19) United States
(12) Patent Application Publication
(10) Pub. No.: US 2004/0141334 A1
(43) Pub. Date: Jul. 22, 2004

(54) Alternate electric current (AC) decorative lamps

(76) Inventor: Min-Hsien Wang, Yanmei (TW)

Correspondence Address: Jing-Shiarn Wang, 4508 Greenwood Rd., Beltsville, MD, 20705, US

(21) Appl. No.: 10/679,346

(22) Filed: Oct. 7, 2003

Related U.S. Application Data
(60) Provisional application No. 60/416,244, filed on Oct. 7, 2002.

(51) Int. Cl. G02B 6/04

(52) U.S. Cl. 362/554; 362/565; 362/566; 362/812

(57) ABSTRACT

The invented decorative lamp includes a graphic designed surface, fiber optics, light sources, a control unit, and an AC (alternated current) pigtail. The graphic designed surface has embedded many small clear glass balls. When the light is on, the clear glass balls reflect the light and make the lamp even more colorful. The outline of the graphic design patterns is defined by many see-through holes. These holes allow lights to shine through. The fiber optics transmits the light. One end of the fiber optics is mounted to these see-through holes that define the lamp graphic pattern. The other end of the fiber optics is assembled and bundled into groups. Each group is then attached to a light source. The light sources are single-colored light emitted diodes (LEDs). A control unit modulates the light emitting pattern and sounds. The control unit is attached to an AC pigtail. The AC pigtail is a connection for AC power source. The use of fiber optics and LEDs allows a more elaborative and complex graphic design on small lamp surface. This lamp is compact and easy to adapt to various decorative settings. Not only the lamp cost less to produce, the lamp has a lower defect rate with a wider range of application.

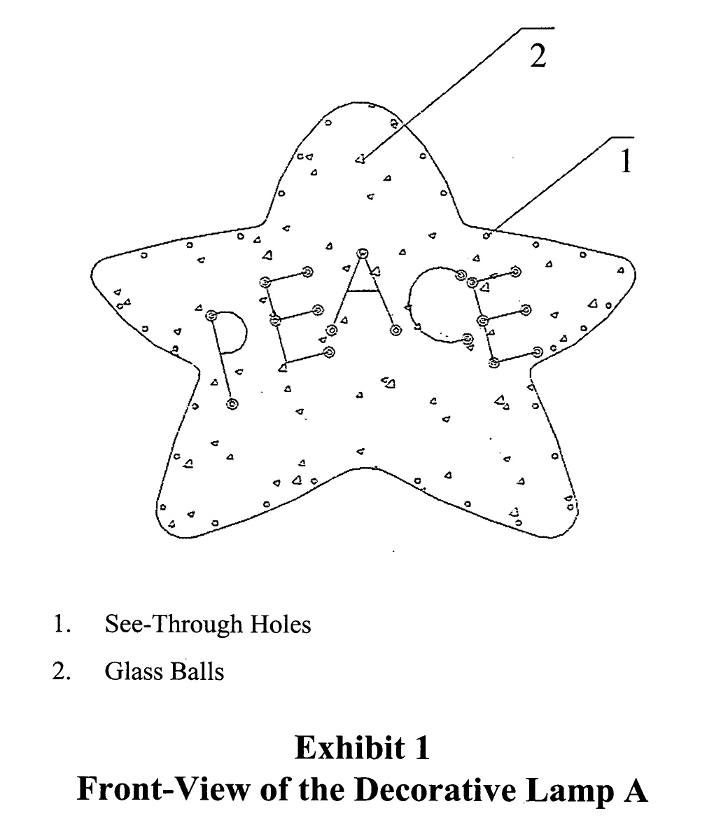

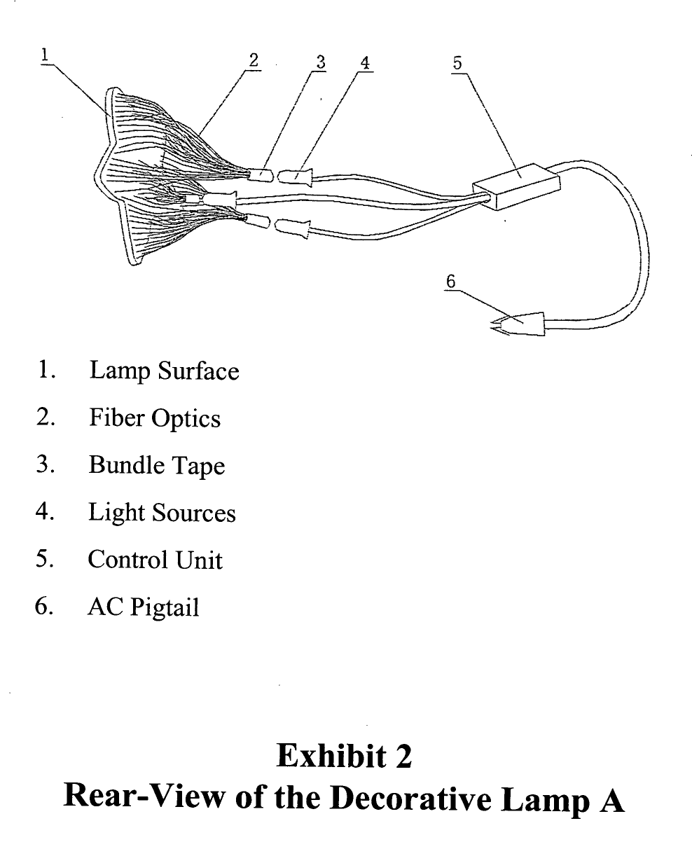

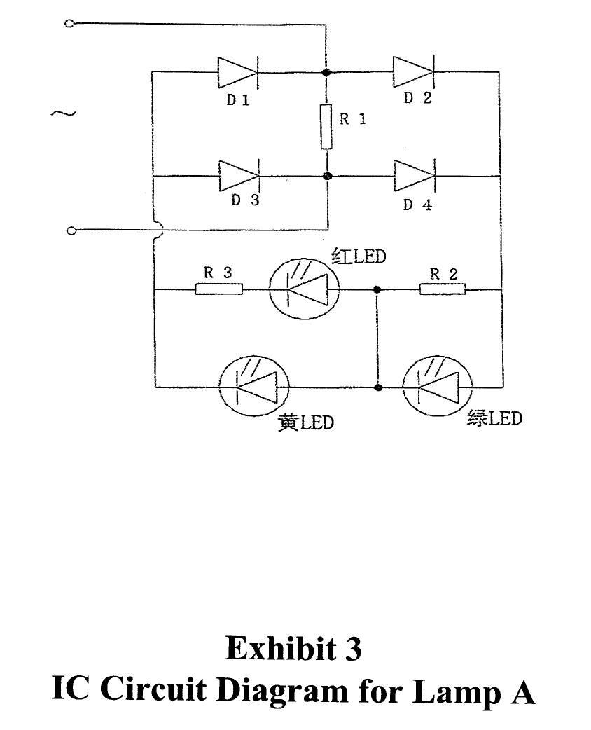

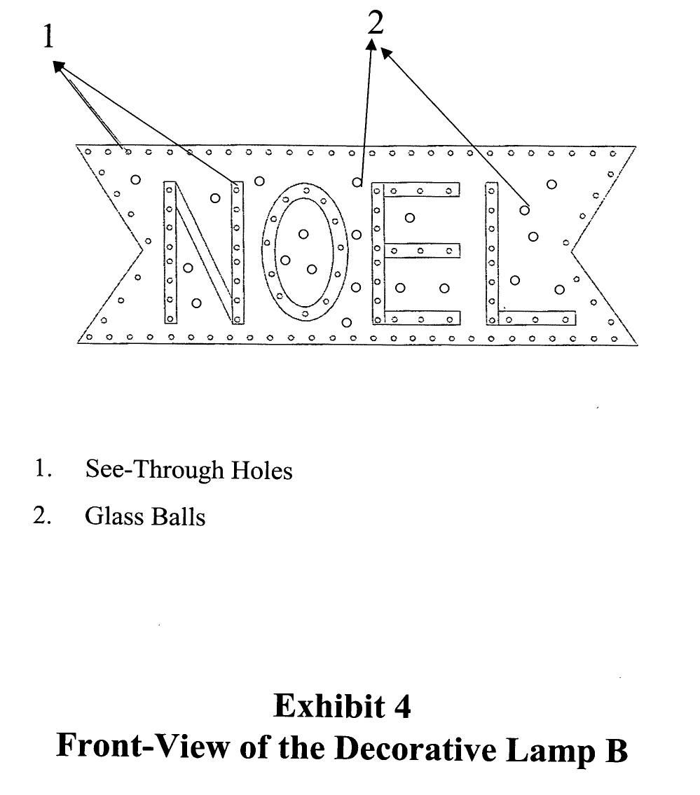

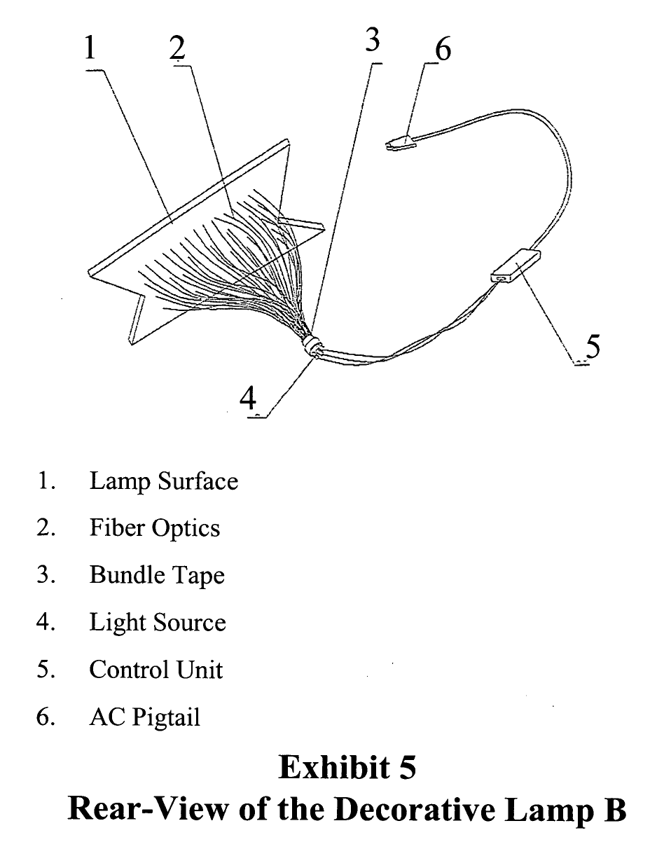

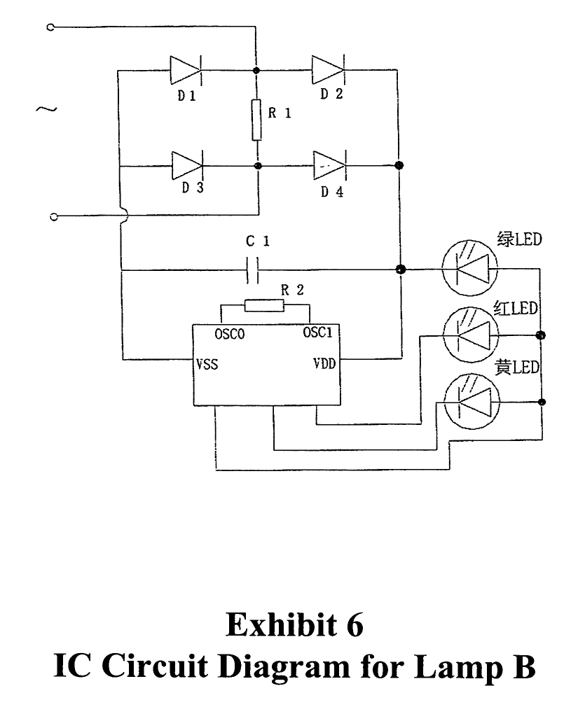

### Priority

This invention is based on the provisional Pattern Application 60/416,244 with filing date Oct. 7, 2002.

### CROSS-REFERENCE TO RELATED APPLICATIONS

Not Applicable

### FEDERALLY SPONSORED RESEARCH OR DEVELOPMENT

Not Applicable

### SEQUENCE OF LISTING, A TABLE, OR A COMPUTER PROGRAM LISTING COMPACT DISK APPENDIX

Not Applicable

### BACKGROUND OF THE INVENTION

1. Field of Invention

The present invention relates to decorative lamps that are used for the festivity atmosphere and particularly to lights and ornaments for Christmas.

2. Background of the Invention

Families and business use the decorative lamps to celebrate the traditional holidays, especially during the Christmas holiday season. Many decorated the Christmas trees, the street, the houses, and buildings with extra lights to enhance the festivity atmosphere. These decorative lights usually wire a series of single colored light bulbs together to illuminate a theme. Due to factors such as wiring, number of bulbs needed, and the high electric power consumption, the Christmas decorative lamps or any other similar decorative lamps usually are simple in design and lack of variations. More complex and elaborate visual effects can be achieved but those effects require a considerably more physical space and materials.

Currently, many decorative lamps have used fiber optics to reduce the weight, volume, and space. Most of these lamps include a single-colored light bulb, colorful platters, fiber optics, and an electric powered motor. The fiber optics is attached to the back surface of the lamps and the colorful platters. When the motor rotates the colorful platters around the light bulb, the colorful lights are transmitted through the fiber optics to achieve the colorful light effects. More light patterns can be achieved by this design. However, the lamps have more components because of its mechanic structure. More mechanic components increase the production complexity, electricity consumption, and the defect rates. Thus, the lamps have a higher production costs. This kind of lamps usually is big and lack of flexibility in decoration.

### BRIEF SUMMARY OF THE INVENTION

The invented decorative lamp includes a graphic designed surface, fiber optics, light sources, a control unit, and an AC pigtail. The lamp surface can be made by a verity of materials with different graphic patterns and shapes. In this invention, the graphic designed surface has embedded with many small clear glass balls. When the light is on, the clear glass balls reflect the light and make the lamp even more colorful. The outline of the graphic design on the lamp surface is defined by many small see-through holes. These holes allow lights to shine through. Fiber optics transmits the lights. In the back of the lamp surface, these holes are filled with fiber optics. In other words, one end of the fiber optics is mounted on the back of the lamp surface around outline of the graphic pattern. The other end of the fiber optics is assembled and attached to the light sources. The fiber optics is assembled and bundled into groups. The number of groups corresponds to the number of light sources. The light sources are single-colored light emitted diodes (LEDs) or other light sources that are deem appropriate. These LEDs link to a control unit. The control unit contains an IC to modulate the light emitting pattern and sounds. The other end of control unit is connected to an AC pigtail. The AC pigtail is for the AC electronic power.

The use of fiber optics allows a more elaborative and complex graphic design in a compact lamp surface. This design requires less materials and production costs than the traditional all-wired lamps and current decorative lamps as previously described in the background section. In addition, the invented decorative lamp has a lower defect rate. It is compact and easy to adapt to various decorative settings. The invented lamp potentially has a wider range of applications and a higher customer acceptance rate.

### BRIEF DESCRIPTION OF THE SEVERAL VIEWS OF THE DRAWING

There are 6 drawings included.

Exhibit 1 illustrates the front-view of the invented decorative lamp A.

Exhibit 2 illustrates the rear-view of the invented decorative lamp A.

Exhibit 3 illustrates IC flow chart included in the control unit of the lamp A.

Exhibit 4 illustrates the front-view of the invented decorative lamp B.

Exhibit 5 illustrated the rear-view of the invented decorative lamp B.

Exhibit 6 illustrates IC flow chart included in the control unit of the lamp B.

Exhibit 1—Front-View of Decorative Lamp A (Lamp Surface)

The lamp surface can be made by a variety of materials with different shapes and graphic design patterns. Exhibit luses “PEACE” on a star shape surface as an example to depict the front-view design of the lamp surface. The invented lamp surface contains two distinct features: (1) a graphic and/or text design pattern with many small see-through holes that define the outline of the graphics and (2) many clear glass balls that are mounted on the area other than the outline of the graphic. The holes allow the lights to shine through. The clear glass balls function as the reflectors that enhance the color of the lamp.

1. Graphic Design Pattern

The graphic design on the lamp surface are painted with colored shining paints. There are many small holes that define the outline of the graphic design. These holes are for lights to shine through. On the back of the surface, these holes are filled with fiber optics.

2. Glass Balls

Glass balls are mounted on the area other than the outline of the graphic. The glass balls serve as the light reflecting devices and make the lamp lighting more dramatic and colorful.

Exhibit 2—Rear-View of the Decorative Lamp A

Exhibit 2 depicts the rear-view design of the invented lamp. The rear-view structure of the invented decorative lamp contains (1) the lamp surface, (2) fiber optics, (3) bundle tape, (4) light source, (5) control unit, and (6) AC pigtail. The followings are descriptions of each part:

1. Rear-View of the Lamp surface A

There are many small see-through holes which are filled with fiber optics.

2. Fiber optics

Fiber optics transmits the lights. One end of the fiber optics is mounted on the back of the lamp around the outline of the graphic pattern, i.e., attached to the see-through holes. The other end of the fibers is assembled accordingly to correspond to the number of light source. The assembled fiber optics then is connected to the light sources. In this design, the fiber optics is bundled into three groups. Each is then connected to a light source.

3. Light sources

The light sources can be single-colored LEDs and any other light sources that are deem appropriate.

4. Control Unit

The control unit contains an IC to modulate the light emitting patterns and sounds.

5. AC pigtail

The AC pigtail is for the AC power connection.

Exhibit 3—IC Circuit Diagram of Lamp Design A

Exhibit 3 illustrates the circuit flow diagram that included in the control unit. This IC controls the current, voltage, and the lighting pattern such as the illuminating sequence, light starting time, and duration. This lighting pattern makes the lamp illuminate with different graphic and intensity, and thus, achieve a more complex and colorful visual effects.

Exhibit 4—Front-View of Decorative Lamp B (Lamp Surface)

Exhibit 4 uses “NOEL” as an example to depict the front-view design of the lamp surface. The invented lamp surface contains two distinct features: (1) a graphic and/or text design pattern with many small see-through holes that define the outline of the graphics and (2) many clear glass balls that are mounted on the area other than the outline of the graphic. The holes allow the lights to shine through. The clear glass balls function as the reflectors that enhance the color of the lamp.

1. Graphic Design Pattern

The graphic design on the lamp surface are painted with colored shining paints. There are many small holes that define the outline of the graphic design (including the shape of the lamp). These holes are for lights to shine through. On the back of the surface, these holes are filled with fiber optics.

2. Glass Balls

Glass balls are mounted on the area other than the outline of the graphic. The glass balls serve as the light reflecting devices and make the lamp lighting more dramatic and colorful.

Exhibit 5—Rear-View of the Decorative Lamp B

The exhibit depicts the rear-view design of the invented lamp. The rear-view structure of the invented decorative lamp contains (1) the lamp surface, (2) fiber optics, (3) bundle tape, (4) light source, (5) control unit, and (6) AC pigtail. The followings are descriptions of each part:

1. Rear-View of the Lamp surface A

There are many small see-through holes which are filled with fiber optics.

2. Fiber optics

The fiber optics transmits the lights. One end of the fiber optics is mounted on the back of the lamp around the outline of the graphic pattern, i.e., attached to the see-through holes. The other end of the fibers is assembled accordingly to correspond to the number of light sources. The assembled fiber optics then is connected to the light sources. In this design, the fiber optics is bundled all together into one group.

3. Light sources

The light sources can be single-colored LEDs and any other light sources that are deem appropriate.

4. Control unit

The control unit contains an IC to modulate the light emitting patterns and sounds.

5. AC pigtail

A. The AC pigtail is for the AC power connection.

Exhibit 6—IC Circuit Diagram of Lamp Design A

Exhibit 6 illustrates the circuit flow diagram that included in the control unit. This IC controls the current, voltage, and the lighting pattern such as the illuminating sequence, light starting time, and duration. This lighting pattern makes the lamp illuminate with different graphic and intensity, and thus, achieve a more complex and colorful visual effects.

### DETAILED DESCRIPTION OF THE INVENTION

The invented decorative lamp includes (1) a lamp surface, (2) fiber optics, (3) light sources, (4) a control unit, and (5) AC pigtail. The lamp surface design can be very complex and elaborate. The graphic design patterns can include a variety of geometric shapes, pictures, and texts. The whole surface and the graphics are painted with colored and shining paints. There are many small see-through holes 1 in Exhibits 1 and 4 that define the outline of the graphic design including the shape of the lamp. The small holes are for lights to shine through. The lamp surface is also embedded with many small glass balls 2 in Exhibits 1 and 4. When lights, these clear glass balls reflect the light and make the lamp even more brilliant and colorful. Exhibits 1 and 4 illustrate the flexibility of the lamp surface design.

Exhibits 2 and 5 illustrate the rear-view of the lamp design. This view illustrates the required components and the assembling mechanism. The components include fiber optics 2, light sources 4, control unit 5, and an AC pigtail 6. The fiber optics transmits lights. One end of the fiber optics is mounted to the see-through holes (as 1 in Exhibits 1 and 4) from the lamp rear surface. The other end of the fiber optics is assembled accordingly and bundled into groups 3 as shown in Exhibits 2 and 5. The number of groups corresponds to the number of light sources. Each group is attached to a light source.

The light sources 4 are single-colored light emitted diodes (LEDs) or other light sources that deem to be appropriated for the design aesthetics and space requirements.

The control unit 5 modulates the light emitting pattern and sounds. It includes an IC that controls the current, voltage, and the lighting pattern such as the illuminating sequence, light starting time, and duration. This lighting pattern makes the lamp illuminate with different graphic and intensity, and thus, achieve a more complex and colorful visual effects. The control unit is connected to the AC pigtail 6.

The AC pigtail 6 is for AC power connection. With this AC pigtail, the lamp is flexibility in decoration.

The invented decorative lamp has the following advantages:

1. The lamp is simple in design. The invented decorative lamp does not contain mechanic components, and thus is simpler in design and compact in volume. The lamp has a lower defect rate and less production costs.

2. The lamp design has a wider range of application. The lamp could be manufactured as many smaller decorative lights such as Christmas ornaments, lighting door wreath, lighting doormats, lighting name tags, etc. The lamp has potentially for a big market in decorative lamps.

3. The lamp uses IC to control the lighting pattern. The lighting pattern design can vary significantly. The lamp would illuminate in different graphics, intensities, and sparkling styles. Thus, the lamp has a more colorful and dramatic visual effect. As a result, the invented decorative lamp, for example, if it is used for Christmas, will be more colorful, adaptable, and compact than current Christmas lights.

4. The combination of fiber optics and pigtail makes the lamp light-weighted and flexible to adapt to different decorative environments. In addition, with the imbedded glass balls, the lamp is more brilliant and colorful—a great decorative ornaments and eye catching piece.

The invented decorative lamp design amends several disadvantages existing in the current decorative lamp market. The invented lamp design uses fiber optics to allow a more elaborative and complex graphic design in a much smaller lamp surface. This lamp is compact and easy to adapt to various decorative settings. Not only the lamp costs less to produce, the lamp has a lower defect rate with a wider range of applications.

### DRAWINGS

What I claim as my invention is:

1. A decorative lamp design comprising (1) a clear glass ball embedded lamp surface in which the outline of the graphic and shape is comprise of many small see-through holes that filled with fiber optics, (2) fiber optics which transmits light from the light source, (3) the light source which are emitted diodes (LEDs) and are connected to a control unit, (4) a control unit that using integrated circuit to control lighting patterns and sounds, and (5) a AC pigtail to connect a AC power outlet.
